(19) United States
(12) Patent Application Publication
(10) Pub. No.: US 2009/0070344 A1
(43) Pub. Date: Mar. 12, 2009

(54) System and method for virtual storage for media service on a portable device

(76) Inventor: Joel Espelien, San Diego, CA (US)

Correspondence Address: PATENTS+TMS, P.C., 2849 W. ARMITAGE AVE., CHICAGO, IL, 60647, US

(21) Appl. No.: 12/283,087

(22) Filed: Sep. 9, 2008

Related U.S. Application Data
(60) Provisional application No. 60/993,393, filed on Sep. 11, 2007.

(51) Int. Cl. G06F 12/16; G06F 17/30; G06F 12/00

(52) U.S. Cl. 707/10; 707/204; 707/E17.01; 707/E17.032

(57) ABSTRACT

A system and a method provide virtual storage for media service on a portable device. The system and the method for virtual storage for media service on the portable device have a content delivery element. The portable device has a storage manager that monitors available storage on the portable device. As the available storage on the portable device decreases to a predetermined threshold, the media service may transmit only the metadata of the media file. The media file may be transmitted from the media service if the user indicates that the media file is to be consumed on the portable device. The media service may allow retrieval of deleted and/or archived media files.

This application claims the benefit of U.S. Provisional Application Ser. No.: 60/993,393 filed Sep. 11, 2007.

### BACKGROUND OF THE INVENTION

The present invention generally relates to a system and a method for virtual storage for media service on a portable device. More specifically, the present invention relates to a system and a method for virtual storage for media service on a portable device that has a content delivery element. The portable device has a storage manager that monitors available storage on the portable device. As the available storage on the portable device decreases to a predetermined threshold, the media service may transmit only the metadata of the media file. The media file may be transmitted from the media service if the user indicates that the media file is to be consumed on the portable device. The media service may allow retrieval of a deleted media file and/or an archived media file. The portable device may store the metadata of the deleted media file or the archived media file but not the deleted media file or the archived media file. The media service may transmit a new copy of the deleted media file or the archived media file if the user indicates that the media file is to be retrieved.

It is generally known, for example, that a user may use an electronic portable device, such as a mobile phone, music player or video player to display, to access, to consume and/or to view media files such as, for example, audio signals, video frames, an audiovisual work and/or an application. The media files are transmitted by, are accessible from and/or are provided from a media service such as an online music store and/or an online video store. Typically, the media files are downloaded directly to the electronic portable device from the media service or loaded onto the device from a personal computer that has downloaded the media files from the media service. The media files are consumed on the electronic portable device. Device storage, however, is limited which requires the user to delete one or more of the media files to store new media files on the electronic portable device. Thus the electronic portable device is utilized as a temporary repository for the media files.

For example, the Apple iTunes system (trademark of Apple, Inc.) utilizes a personal computer to download media files from a media service, and the media files are stored on the personal computer. Copies of the media files are transmitted to the electronic portable device. As further example, the Verizon VCAST (trademark of Verizon Communications, Inc.) provides dual delivery of media files. The dual delivery is transmittal of one copy of a media file to the personal computer and one copy of the media file to a mobile phone.

The traditional systems of storage of media service on portable devices pose several problems. Multiple applications, such as, for example, camera functions, game functions, application functions and/or media functions, may compete for the use of the storage on the electronic portable device. Thus, storage of new media files may be limited by the storage of previously obtained media files and/or the use of storage by other applications on the electronic portable device.

Additionally, electronic portable devices are prone to loss and damage. If loss and/or damage necessitate acquisition of a new portable device, the new electronic portable device does not have the media files stored in the previous electronic portable device. To consume previously obtained media files on the new electronic portable device, the user may need to purchase the previously obtained media files again.

The user often stores new media files on the electronic portable device. However, the user may need to delete one or more of the media files to store the new media files on the electronic portable device. Thus, the new media files may cause the user to delete a media file that the user would not otherwise delete. Further, the user may not obtain the new media files because the user may not be willing to delete certain previously acquired files. Thus, limited memory on the portable device restricts the available media files on the portable device at any given time which also limits enjoyment of using the portable device. Additionally, loss or damage to the portable device may necessitate acquisition of a new portable device that does not have the media files on the previously owned or previously used electronic portable device.

A need, therefore, exists for a system and a method for virtual storage for media service on a portable device. Additionally, a need exists for a system and a method for virtual storage for media service on a portable device that has a content delivery element. Further, a need exists for a storage manager that monitors available storage on the portable device. Still further, a need exists for a storage manager that indicates that the media service should provide virtual storage as the available storage on the portable device decreases to a predetermined threshold. Still further, a need exists for a system and a method for virtual storage for media service on portable devices that store metadata of deleted or archived media file. Moreover, a need exists for maintaining a record of deleted files and/or archived files on a portable device. Furthermore, a need exists for providing recovery of deleted files on a portable device.

### SUMMARY OF THE INVENTION

The present invention generally relates to a system and a method for virtual storage for media service on a portable device. More specifically, the present invention relates to a system and a method for virtual storage for media service on a portable device that has a content delivery element. The portable device may have a storage manager that monitors available storage on the portable device. As the available storage on the portable device decreases to a predetermined threshold, the media service may transmit only the metadata of the media file. The media service may allow retrieval of deleted and/or archived media files. The portable device may store the metadata of a media file but not the media file.

It is, therefore, an advantage of the present invention to provide a system and a method for virtual storage for media service on a portable device.

Another advantage of the present invention is to provide a system and a method for virtual storage for media service on a portable device that compiles a list of media files transmitted to the portable device.

And, another advantage of the present invention is to provide a storage manager that monitors available storage on the portable device and indicates that the media service should provide virtual storage.

Yet another advantage of the present invention is to provide a system and a method for virtual storage for media service on a portable device that provides virtual storage as the available storage on the portable device decreases to a predetermined threshold.

A further advantage of the present invention is to provide a system and a method for virtual storage for media service on a portable device that store the metadata of a media file of a deleted media file.

And, another advantage of the present invention is to provide a system and a method for virtual storage for media service on a portable device that allow recovery of deleted files for the portable device.

Yet another advantage of the present invention is to provide a system and a method for virtual storage for media service on a portable device that maintain a record of deleted media files and/or archived media files on the portable device.

Yet another advantage of the present invention is to display the deleted media files and/or the archived media files in a content menu on the portable device even though the files associated with the media files are no longer available.

Moreover, another advantage of the present invention is to provide a system and a method for virtual storage for media service on a portable device that provide the user with a perception of unlimited personal storage.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of a virtual storage system for media service on a portable device in an embodiment of the present invention.

FIG. 2 illustrates a flowchart of a method for virtual storage of media service on a portable device in an embodiment of the present invention.

FIG. 3 illustrates a flowchart of a method for virtual storage of media service on a portable device in an embodiment of the present invention.

FIG. 4 illustrates a flowchart of a method for virtual storage of media service on a portable device in an embodiment of the present invention.

### DETAILED DESCRIPTION OF THE PREFERRED EMBODIMENTS

The present invention generally relates to a system and a method for virtual storage for media service on a portable device. More specifically, the present invention relates to a system and a method for virtual storage for media service on a portable device that has a content delivery element. The portable device has a storage manager that monitors available storage on the portable device. As the available storage on the portable device decreases to a predetermined threshold, the media service may transmit only the metadata of the media file. The media file may be transmitted from the media service if the user indicates that the media file is to be consumed on the portable device. The media service may allow retrieval of a deleted medai file and/or an archived media file. The portable device may store metadata of the deleted media file or the archived media file, but not the deleted media file or the archived media file. The media service may transmit a new copy of the deleted or archived media file if the user indicates that the media file is to be retrieved.

A record of the deleted media file or the archived media file may be maintained by the content delivery element of the media service. The deleted media file and/or the archived media file may be shown in a content menu on the portable device even though the files associated with the media files are no longer available. Thus, the user may have a perception of unlimited personal storage.

Referring now to the drawings wherein like numerals refer to like parts, FIG. 1 generally illustrates a system 10 for virtual storage for media service on a portable device. The system 10 may have a media service 12 connected to a data communication network 18 (hereinafter “the network 18”). A portable device 20 may be connected to and/or may be in communication with the media service 12 via the network 18. The media service 12 and the portable device 20 may be remote with respect to each other.

The media service 12 may be, for example, a media content provider, a media content library and/or the like. The media content provider may be, for example, a cable television provider, a satellite television provider, a satellite radio provider, an internet radio provider, a streaming audio and/or video provider and/or the like. The media content library may be a media content retailer and/or a distributor such as, for example, a media store, a file-sharing store, an online media distributor and/or the like. It should be understood that the media service 12 may be any source capable of transferring a media file to the portable device 20.

The media file may be a digital multimedia file (hereinafter “the multimedia file”), such as, for example, an audio signal, video frames, a data feed, a data stream, a musical composition, a radio program, an audio book and/or an audio program. Further, the media file may be, for example, a cable television program, a satellite television program, a public access program, a motion picture, a music video, an animated work, a video program, a video game and/or a soundtrack and/or a video track of an audiovisual work, a dramatic work, a film score, an opera and/or the like. Still further, the media file may be an application, such as, for example, an email application, a Global Positioning System (“GPS”) application, an instant messaging application and/or the like. The media service 12 may transmit to the portable device 20 one or more of the media files as known to one of ordinary skill in the art. The present invention should not be limited to a specific embodiment of the media file. It should be understood that the media file may be any media file as known to one of ordinary skill in the art.

Each media file may have metadata associated with, related to and/or corresponding to the media file. The metadata may be, for example, a code, an identifier, a tag, a communication and/or information. The metadata may be formatted in a standard data format, such as, for example, XML, RDF, RSS, MathML, XHTML, SVG, cXML and/or the like. The present invention should not be limited to a specific embodiment of the standard data format of the metadata and/or to a specific embodiment of the metadata.

The communication of the metadata may be, for example, text, a graphic, a voice recording, a video recording, a conferencing recording, a comment, a note, a review, a correspondence, a commentary, a message, a discussion, a notice, a bulletin, a memorandum, news and/or the like which may be related to, may be associated with and/or may be based on the media file.

The information of the metadata may be, for example, a name of the media file, a type of the media file and/or the like. The type of the media file may be, for example, a musical composition, a radio program, an audio book, an audio program, a television program, a movie, a music video, an animated work, a video program, a video game and/or a soundtrack and/or a video track of an audiovisual work, a dramatic work, a film score and/or an opera and/or the like. Further, the information may be, for example, a year of the multimedia file, an artist associated with the multimedia file, a publisher or a copyright owner of the multimedia file, a genre associated with the multimedia file and/or a length of time of the multimedia file. Moreover, the information may be, for example, a content rating of the multimedia file, a language associated with the multimedia file, a key word associated with the multimedia file, a review of the multimedia file, a source of the multimedia file and/or the like. The present invention should not be limited to a specific embodiment of the communication and/or the information of the metadata.

The portable device 20 may be capable of consuming, of receiving, of processing, and/or of displaying the media file and/or the metadata associated with the media file. The portable device 20 may have and/or may be connected to a display 21 for viewing, for consuming and/or for displaying the media file and/or the metadata associated with the media file. The portable device 20 may be, for example, a mobile cellular telephone, a personal digital assistant (“PDA”), a 4G mobile device, a 3G mobile device, a 2.5G mobile device, an internet protocol (hereinafter “IP”) video cellular telephone, an ALL-IP electronic device, a satellite radio receiver, a portable digital audio player, a portable digital video player, a laptop computer and/or the like. A user interface 17 on the portable device 20, such as, for example, buttons, a touchpad, a touchscreen and/or a trackball, may allow a user to provide input to the portable device 20. It should be understood that the portable device 20 may be any portable device capable of transmitting, of receiving, of processing, of consuming and/or of displaying the media file and/or the metadata associated with the media file as known to one having ordinary skill in the art.

The network 18 may be a fixed network, such as, for example, a cabled network, a permanent network and/or the like. In an embodiment, the network 18 may be a temporary network, such as, for example, a modem network, a null modem network and/or the like. In an embodiment, the network 18 may be, for example, a local area network, a metropolitan area network, a wide area network, a personal area network and/or the like. Alternatively, the network 18 may be a wireless network, such as, for example, a wireless metropolitan area network, a wireless local area network, a wireless personal area network, a global standard network, a personal communication system network, a pager-based service network, a general packet radio service, a universal mobile telephone service network, a radio access network and/or the like. The present invention should not be limited to a specific embodiment of the network 18. It should be understood that the network 18 may be any network capable of delivering the media file and/or the metadata to the portable device 20 as known to one having ordinary skill in the art.

The media service 12 may deliver, may distribute, may stream, may broadcast and/or may transmit the media file and/or the metadata associated with the media file to the portable device 20 via the network 18. Service authorization, subscription information and/or authentication information may be transmitted from the portable device 20 to the network 18 and/or the media service 12 to indicate that the portable device 20 is authorized to receive the media file. The media file may be consumed by, may be displayed to, may be experienced by and/or may be reproduced to the user via the portable device 20. It should be understood that the media file may be delivered to the portable device 20 by any means of transmission over the network 18 as known to one having ordinary skill in the art.

The user may obtain, may acquire and/or may purchase a subscription to the media service 12. The user may obtain the subscription from the media service 12 to receive, to consume and/or to experience the media file via the portable device 20 and/or the network 18. Further, the subscription may provide the user and/or the portable device 20 with access to the media files of the media service 12. The user may not be charged for each media file transmitted to the portable device 20 and/or may not be limited in a number of the media files that may be transmitted to the portable device 20. The subscription may be associated with, may be assigned to and/or may correspond to the user and/or the portable device 20. As a result, the portable device 20 may access, may download and/or may consume the media file from the media service 12 via the network 18.

The user may access and/or may display a list of media files available from the media service 12 via the network 18. The list of the media files available from the media service 12 may be based on the subscription of the user. The list of the media files available from the media service 12 may display the available media files in a display format, such as, for example, rows and/or columns. The list of media files available from the media service 12 may display the metadata associated with the available media files. The list of media files available from the media service 12 may display, for example, properties of the media file, such as, for example, a time and/or a duration associated with the media file, the name of the media file, the type of the media file, the genre associated with the media file, the content rating of the media file, the key word associated with the media file, the source of the media file and/or the like.

The media file which may be present within a list of media files available from the media service 12 may be selected, may be highlighted and/or may be identified by the user using the user interface 17. The user may request and/or may signal the media service 12 to transfer and/or to transmit the media file to the portable device 20 via the network 18. The media service 12 may transmit the media file to the portable device 20 based on the subscription of the user 11. The media service 12 may assign to the user a monetary cost for purchase of the media file. The portable device 20 may receive the media file from the media service 12 via the network 18.

The media file may be stored in the portable device 20. The portable device 20 may display a list of stored media files. The media file may be accessed, may be consumed by and/or may be experienced by the user via the portable device 20. The user may utilize the user interface 17 to select the media file from the list of the stored media files to access, consume and/or experience the media file. The portable device 20 may have local storage 24, and/or the local storage 24 may be accessible by the portable device 20. The media file may be stored in the local storage 24 of the portable device 20. The list of the stored media files may be determined from the media files stored on the local storage 24. The local storage 24 may permanently and/or may temporarily store the media file for consumption by the portable device 20. The user may utilize the user interface 17 to store the media file in the local storage 24 and/or delete a stored media file from the local storage 24. The user may use the list of stored media files to select the stored media file to delete from the local storage 24. The local storage 24 may be a data storage device, such as, for example, a flash memory/memory card, a solid state semiconductor memory, a magnetic bubble memory, a disk storage, a database and/or the like. It should be understood that the local storage 24 may be any local storage as known to one of ordinary skill in the art.

The media service 12 may have a content delivery element 30. The content delivery element 30 may be connected to and/or in communication with the portable device 20 via the network 18. The content delivery element 30 may generate a list of the media files transmitted to the portable device 20 by the media service 12. If a new media file is transmitted to the portable device 20, the content delivery element 30 may update the list of the media files transmitted to the portable device 20. If the media file is deleted from the portable device 20, the content delivery element 30 and/or the list of the media files transmitted to the portable device 20 may provide a record that the media file was transmitted to the portable device 20.

The portable device 20 may have a storage manager 40. The storage manager 40 may monitor an amount of the local storage 24 that has been used. Therefore, the storage manager 40 may monitor an amount of the local storage 24 that may be available. As the media files are stored on the local storage 24, the storage manager 40 may update the amount of the local storage 24 that may be in use and/or the amount of the local storage 24 that may be available. For example, if the new media file is transmitted to the portable device 20 and/or stored on the local storage 24, the storage manager 40 may update the amount of the local storage 24 that may be in use to reflect that more of the local storage 24 may be in use. Correspondingly, if the new media file is transmitted to the portable device 20 and/or stored on the local storage 24, the storage manager 40 may update the amount of the local storage 24 that may be available to reflect that less of the local storage 24 may be available. As further example, if the media file is deleted from the local storage 24 of the portable device, the storage manager 40 may update the amount of the local storage 24 that may be in use to reflect that less of the local storage 24 may be in use. Correspondingly, if the new media file is deleted from the local storage 24 of the portable device 20, the storage manager 40 may update the amount of the local storage 24 that may be available to reflect that more of the local storage 24 may be available.

The storage manager 40 may have a predetermined memory threshold. The memory threshold may be established and/or may be adjusted by the user and/or the media service 12. If the amount of the local storage 24 that may be available and/or the amount of the local storage 24 that may be in use matches the predetermined memory threshold, the portable device 20 may initiate virtual storage. Virtual storage may allow the user to consume a media file that is not stored on the portable device 20.

For virtual storage, the media service 12 may not transmit a media file selected for transmittal to the portable device 20, but the media service 12 may only transmit the metadata associated with the media file selected for transmittal. Thus, the media file selected for transmittal may not be stored in the local storage 24 of the portable device 20. The metadata associated with the media file may allow the user to select the media file not stored in the portable device 20 for consumption on the portable device 20. If the media file that is not stored on the portable device 20 is selected for consumption, the portable device 20 may request the media file not stored on the portable device from the media service. The media service 12 may transmit the media file that is not stored on the portable device 20 to the portable device 20 via the network 18. Therefore, the user may have a perception that the portable device 20 provides unlimited storage. If the amount of the local storage 24 that may be available and/or the amount of the local storage 24 that may be in use matches the predetermined threshold, the user may consume the media files on the portable device 20 via the transmittal of the media files from the media service 12.

For example, the user and/or the portable device 20 may request an audio composition file from the media service 12. If the amount of the local storage 24 that is available and/or the amount of the local storage 24 that is in use matches the predetermined threshold, the media service 12 may transmit the metadata associated with the audio composition file, but may not transmit the audio composition file. Thus, the audio composition file selected for transmittal is not stored in the local storage 24 of the portable device 20. The metadata associated with the audio composition file may allow the user to select the audio composition for consumption on the portable device 20. If the audio composition file that is not stored on the portable device 20 is selected for consumption, the portable device 20 may request the audio composition file that is not stored on the portable device 20 from the media service 12. The media service 12 may transmit the audio composition file to the portable device 20 via the network 18. Transmittal of the audio composition file may allow consumption of the audio composition file on the portable device 20.

Therefore, the audio composition file may not decrease the amount of the local storage 24 that may be available and/or may not increase the amount of the local storage 24 that may be in use until consumption of the audio composition file is initiated by the user. Since a physical copy of the media file may not be maintained on the portable device 20, the virtual storage makes the portable device 20 more efficient relative to devices that require transmittal of the media file from a personal computer that downloaded the media files from the media service 12.

The user may delete the media file from the portable device 20 which may remove the media file from the local storage 24 of the portable device 20. If the user deletes the media file from the local storage 24, the local storage 24 may maintain storage of the metadata associated with the deleted media file in the local storage 24. The user may later wish to retrieve the deleted media file. The metadata associated with the deleted media file may allow the user to select the deleted media file for retrieval. If the deleted media file is selected for retrieval, the portable device 20 may request a new copy of the deleted media file from the media service 12.

The media service 12 may verify that the media file was previously transmitted to the portable device 20 and/or may authorize a second transmittal of the media file to the portable device 20. For example, the media service may use the service authorization, the subscription information and/or the authentication information to determine that the portable device 20 is authorized for the second transmittal of the media file. As a further example, the content delivery element 30 and/or the list of the media files transmitted to the portable device 20 may indicate that the media file was previously transmitted to the portable device 20. Therefore, the content delivery element 30 and/or the list of the media files transmitted to the portable device 20 may indicate that the portable device 20 may be authorized for the second transmittal of the media file. The media service 12 may transmit the new copy of the deleted media file to the portable device 20 via the network 18. The new copy of the deleted media file may be stored in the local storage 24 of the portable device 20. The new copy of the deleted media file may be consumed on the portable device 20.

The virtual storage may provide more efficiency for the portable device 20 relative to devices that require a physical copy of the media file be maintained on the device. The virtual storage may allow the user to retrieve the deleted media file without ordering and/or purchasing a new copy of the deleted media file.

For example, the user may obtain a video game file for the portable device 20. The video game file may be transmitted from the media service 12 to the portable device 20 via the network 18. If a user wishes to delete the video game file, the video game file may be deleted from the local storage 24, but the metadata associated with the video game file may remain stored in the local storage 24. The portable device 20 may use the metadata associated with the archived video game to allow the user to select the video game file for retrieval. If the user selects the archived video game file for retrieval, the portable device 20 may request a new copy of the video game file from the media service 12. The media service 12 may transmit the new copy of the video game file to the portable device 20 via the network 18. The new copy of the video game file may be stored in the local storage 24 of the portable device 20 and/or may be deleted again at a later time.

The user may wish to archive the media file if the media file does not need to be available for consumption until a later time. If a user wishes to archive the media file, the media file may be deleted from the local storage 24, but the metadata associated with the media file may remain stored in the local storage 24. The portable device 20 may use the metadata associated with the archived media file to allow the user to select the archived media file for retrieval. If the user selects the archived media file for retrieval, the portable device 20 may request a new copy of the archived media file from the media service 12. The media service 12 may transmit the new copy of the archived media file to the portable device 20 via the network 18. The new copy of the archived media file may be stored in the local storage 24 of the portable device 20. The new copy of the archived media file may be consumed on the portable device 20.

Therefore, the archived media file may not decrease the amount of the local storage 24 that may be available until consumption of the archived media file is initiated by the user. The archived media file may not increase the amount of the local storage 24 that may be in use until consumption of the archived media file is initiated by the user. The virtual storage allows the user to retrieve the archived media file without ordering and/or purchasing a new copy of the archived media file. The virtual storage may provide more efficiency to the portable device 20 relative to devices that may require a physical copy of the media file that may be maintained on the device. Further, the user may have the perception that the media file was maintained in the local storage 24.

For an example of archiving, the user may wish to archive a Christmas song file if a current time of year is not proximate to Christmas. The Christmas song file may have been transmitted from the media service 12 to the portable device 20 via the network 18. If a user wishes to archive the Christmas song file, the Christmas song file may be deleted from the local storage 24, but the metadata associated with the Christmas song file may remain stored in the local storage 24. The portable device 20 may use the metadata associated with the archived Christmas song file to allow the user to select the Christmas song file for retrieval. If the user selects the archived Christmas song file for retrieval, the portable device 20 may request a new copy of the Christmas song file from the media service 12. The media service 12 may transmit the new copy of the Christmas song file to the portable device 20 via the network 18. The new copy of the archived Christmas song file may be stored in the local storage 24 of the portable device 20 and/or may be archived again at a later time. Therefore, the archived Christmas song file may not decrease the amount of the local storage 24 that may be available and/or may not increase the amount of the local storage 24 that may be in use until retrieval of the archived Christmas song file is initiated by the user. Further, the user may have the perception that the Christmas song file was maintained in the local storage 24.

The content delivery element 30 of the media service 12 may indicate that the portable device 20 and/or the user previously acquired the media file. Therefore, the content delivery element 30 may provide security to the virtual storage by validating that the portable device 20 and/or the user are authorized to receive the new copy of the media file. As a result, the user and/or the portable device 20 may obtain, may access, may consume and/or may experience the new copy of the media file and/or may obviate the need to maintain a copy of the deleted media file and/or the archived media file on the local storage 24.

Further, if the portable device 20 is lost and/or damaged, the user may obtain a new portable device 50. The new portable device 50 may be connected to the media service 12 by the network 18. The content delivery element 30 may maintain the list of the media files transmitted to the portable device 20. The content delivery element 30 and/or the list of the media files transmitted to the portable device 20 may validate that the media file was transmitted to the portable device 20. Therefore, the media service 12 may enable the user to re-acquire the media files previously transmitted from the media service 12 to the portable device 20. The new media service 12 may transmit new copies of the media files previously consumed on the portable device 20 to the new portable device 50 via the network 18.

For example, the user may have a subscription to the media service 12 and/or may have obtained a motion picture file from the media service 12 on the portable device 20. The user may have lost and/or damaged the portable device 20 and /or may acquire the new portable device 50. The media service 12 may verify that the subscription of the user is valid on the new portable device 50 and/or the new portable device 50 may request a new copy of the motion picture file from the media service 12. The content delivery element may validate that the motion picture file was previously transmitted to the portable device 20 and/or the media service 12 may transmit the new copy of the motion picture file to the new portable device 50.

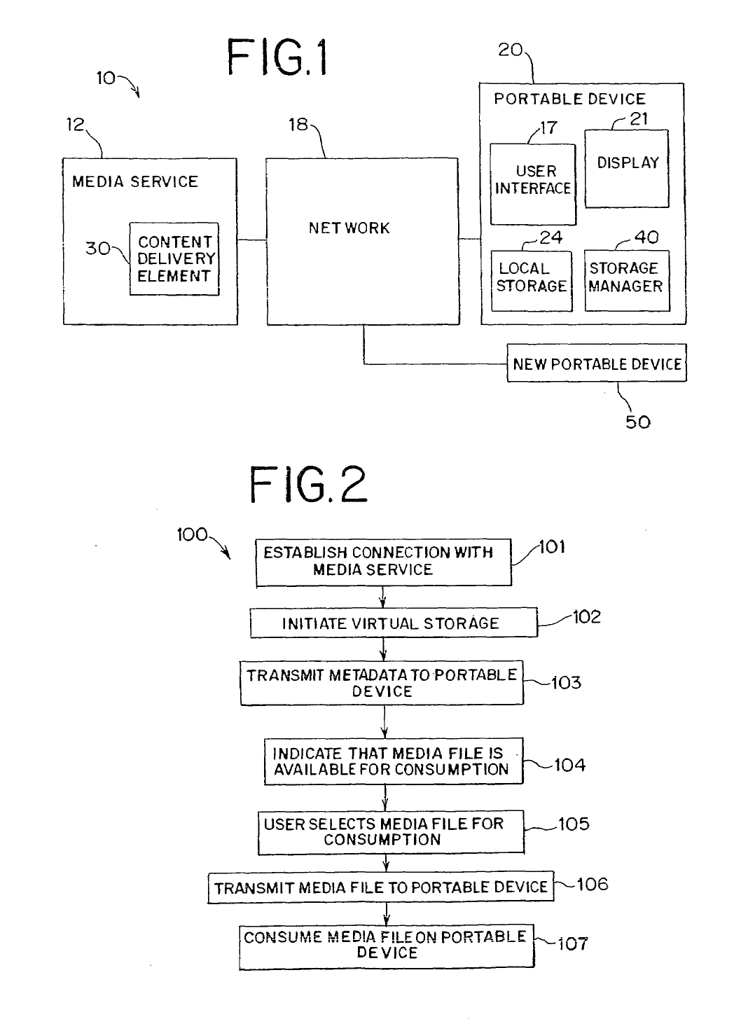

FIG. 2 generally illustrates a method 100 for virtual storage for media service on a portable device in an embodiment of the present invention. A connection may be initiated between the media service 12 and the portable device 20 via the network 18 as shown at step 101. Service authorization, subscription information and/or authentication information may be exchanged via the connection. The service authorization, the subscription information and/or the authentication information may be transmitted from the portable device 20 to the network 18 and/or the media service 12. User input may direct the portable device 12 to obtain the media file from the network 18 and/or the media service 12.

The media service 12, the storage manager 40, the network 18 and/or the portable device 20 may determine whether to initiate the virtual storage as shown at step 102. For example, the virtual storage may be initiated if the amount of the local storage 12 that may be in use and/or the amount of the local storage 12 that may be available matches the predetermined threshold. The metadata associated with the media file may be transmitted to the portable device 20 via the connection as shown at step 103. The portable device 20 may indicate to the user that the media file is available for consumption as shown at step 104. For example, the media file may be listed in a menu that may be displayed on the portable device 20. User input may indicate that the user wishes to consume the media file as shown at step 105. For example, the user may select the media file from the menu displayed on the portable device 20. In response to the user input, the media service 12 may transmit the media file to the portable device 20 via the network 18 as shown at step 106. The user may then consume the media file on the portable device 20 as shown at step 107.

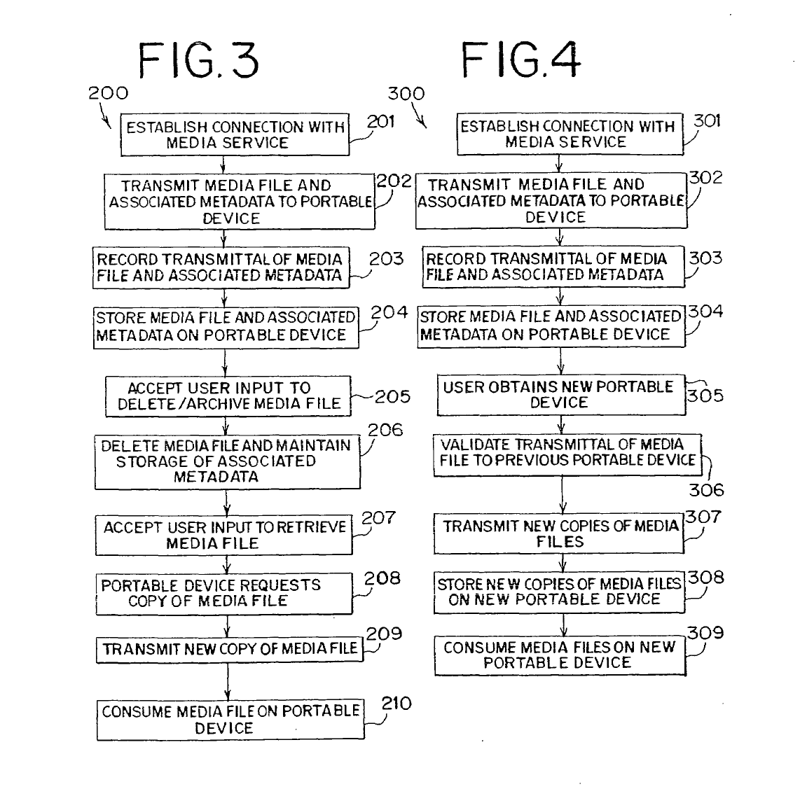

FIG. 3 generally illustrates a method 200 for virtual storage for media service on a portable device in an embodiment of the present invention. A connection may be initiated between the media service 12 and the portable device 20 via the network 18 as shown at step 201. Service authorization, subscription information and/or authentication information may be exchanged via the connection. The service authorization, the subscription information and/or the authentication information may be transmitted from the portable device 20 to the network 18 and/or the media service 12. The media service 12 may transmit the media file and the metadata associated with the media file to the portable device 20 via the network 18 as shown at step 202. The media service 12 and/or the content delivery element 30 may record that the media file was transmitted to the portable device 20 as shown at step 203. The content delivery element 30 of the media service 12 may create a list of the media files transmitted to the portable device 20 by the media service 12. If a new media file is transmitted to the portable device 20, the content delivery element 30 may update the list of the media files transmitted to the portable device 20. If the media file is deleted from the portable device 20, the content delivery element 30 may have a record of transmittal of the media file to the portable device 20.

The media file and the metadata associated with the media file may be stored on the portable device 20. For example, the media file and the metadata associated with the media file may be stored in the local storage 24 of the portable device as shown at step 204. The user may consume the media file on the portable device 20.

The user may determine that the media file should be deleted and/or archived. The user input may direct the portable device 20 to delete and/or to archive the media file as shown at step 205. The portable device 20 may delete the media file, but the portable device 20 may maintain storage of the metadata associated with the media file as shown at step 206. The media file may not be consumed if the media file is deleted and/or archived. If the user wishes to retrieve the media file, the portable device 20 may request the media file from the media service 12 as shown at step 207. The media service 12 may verify that the media file was previously transmitted to the portable device 20 and/or may authorize a second transmittal of the media file to the portable device 20 as shown at step 208. For example, the media service may use the service authorization, the subscription information and/or the authentication information to determine that the portable device 20 is authorized for the second transmittal of the media file. As a further example, the list of the media files transmitted to the portable device 20 may indicate that the media file was previously transmitted to the portable device 20 and that the portable device 20 is authorized for the second transmittal of the media file. The list of the media files transmitted to the portable device 20 may be compiled by the content delivery element 30, as previously set forth.

The media service 12 may transmit a new copy of the media file to the portable device 20 via the network 18 as shown at step 209. The new copy of the media file may be stored by the portable device 20 in the local storage 24 of the portable device 20. The new copy of the media file may allow the media file to be consumed by the user on the portable device 20 as generally shown at step 210.

FIG. 4 generally illustrates a method 300 for virtual storage for media service on a portable device in an embodiment of the present invention. A connection may be initiated between the media service 12 and the portable device 20 via the network 18 as shown at step 301. Service authorization, subscription information and/or authentication information may be exchanged via the connection. The service authorization, the subscription information and/or the authentication information may be transmitted from the portable device 20 to the network 18 and/or the media service 12. The media service 12 may transmit the media file and the metadata associated with the media file to the portable device 20 via the network 18 as shown at step 302. The media service 12 and/or the content delivery element may record that the media file was transmitted to the portable device 20 as shown at step 303. The content delivery element 30 of the media service 12 may create a list of the media files transmitted to the portable device 20 by the media service 12.

The media file and/or the metadata associated with the media file may be stored on the portable device 20. For example, the media file and/or the metadata associated with the media file may be stored in the local storage 24 of the portable device 20 as shown at step 304. The user may consume the media file on the portable device 20.

The portable device 20 may become lost and/or damaged. The user may obtain a new portable device 50 as shown at step 305. The media service 12 may validate that the user obtained the media file on the portable device 20 as shown at step 306. For example, the content delivery element 30 of the media service 12 may utilize the list of the media files transmitted to the portable device 20 to validate that the user obtained the media file on the portable device 20. As a further example, the subscription information of the user may be transmitted from the new portable device 50. The subscription information of the user may validate that the user obtained the media file on the portable device 20. Therefore, the media service 12 may enable the user to re-acquire the media file previously transmitted from the media service 12 to the portable device 20.

The new media service 12 may transmit new copies of the media files previously transmitted to the portable device 20 to the new portable device 50 as shown at step 307. The new copies of the media files may be stored by the new portable device 50 as shown at step 308. The new copies of the media files may allow the media files to be consumed by the user on the new portable device 50 as shown at step 309.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

1. A method for virtual storage, the method comprising the steps of:
connecting a portable device to a media service wherein the portable device is connected to the media service by a network;
displaying a list of media files available from the media service wherein the portable device displays the list of media files available from the media service;
selecting a media file from the list of media files available from the media service;
transmitting metadata from the media service to the portable device via the network wherein the metadata is associated with the media file selected from the list of media files available from the media service and further wherein the metadata is transmitted from the media service to the portable device without the media file;
storing the metadata on the portable device;
indicating that the media file is available for consumption on the portable device wherein the portable device indicates that the media file is available for consumption;
selecting the media file for consumption on the portable device; and
transmitting the media file from the media service to the portable device via the network wherein the media file is transmitted from the media service to the portable device after selection of the media file for consumption.

2. The method of claim 1 further comprising the step of:
displaying the metadata with the list of the media files available from the media service.

3. The method of claim 1 further comprising the step of:
determining if an amount of storage in use by the portable device meets a predetermined threshold wherein the metadata is transmitted without the media file if the amount of storage in use by the portable device meets the predetermined threshold.

4. The method of claim 1 further comprising the step of:
verifying that the portable device has a subscription to the media service.

5. The method of claim 1 further comprising the step of:
consuming the media file on the portable device.

6. A method for virtual storage, the method comprising the steps of:
connecting a portable device to a media service wherein the portable device is connected to the media service by a network;
displaying a list of media files available from the media service wherein the portable device displays the list of media files available from the media service;
selecting a media file from the list of media files available from the media service;
transmitting metadata and a first copy of the media file from the media service to the portable device via the network wherein the metadata is associated with the media file;
storing the metadata and the first copy of the media file on the portable device;
deleting the first copy of the media file from the portable device;
accepting user input to retrieve the media file; and
transmitting a second copy of the media file from the media service to the portable device via the network.

7. The method of claim 6 further comprising the step of:
consuming the media file on the portable device after the second copy of the media file is transmitted from the media service to the portable device.

8. The method of claim 6 further comprising the step of:
consuming the media file on the portable device after the first copy of the media file is transmitted from the media service to the portable device and before the first copy of the media file is deleted.

9. The method of claim 6 further comprising the step of:
compiling a list of media files transmitted to the portable device wherein the media service transmits the second copy of the media file from the media service to the portable device if the list of media files transmitted to the portable device indicates that the media file was transmitted to the portable device.

10. The method of claim 6 further comprising the step of:
selecting the metadata wherein selection of the metadata provides the user input to retrieve the media file.

11. The method of claim 6 further comprising the step of:
verifying that the portable device is authorized to receive the second copy of the media file.

12. The method of claim 6 wherein the first copy of the media file is deleted in response to a command entered into the portable device by a user.

13. The method of claim 6 further comprising the step of:
storing the second copy of the media file on the portable device.

14. The method of claim 6 further comprising the step of:
maintaining storage of the metadata on the portable device when the first copy of the media file is deleted.

15. The method of claim 6 further comprising the step of:
displaying a list of media files stored on the portable device wherein the first copy of the media file is deleted from the portable device if the media file is selected from the list of media files stored on the portable device.

16. A method for virtual storage wherein a user has a first portable device and subsequently obtains a second portable device, the method comprising the steps of:
connecting the first portable device to a media service wherein the first portable device is connected to the media service by a network;
transmitting a first copy of a media file from the media service to the first portable device via the network;
storing the first copy of the media file on the first portable device;
connecting the second portable device to the media service via the network;
determining if the second portable device is authorized to receive a second copy of the media file;
transmitting a second copy of the media file from the media service to the second portable device via the network wherein the media service transmits the second copy of the media file from the media service to the second portable device if the second portable device is authorized to receive the second copy of the media file; and
storing the second copy of the media file on the second portable device.

17. The method of claim 14 further comprising the step of:
transmitting metadata from the media service to the first portable device via the network wherein the metadata is associated with the media file.

18. The method of claim 16 further comprising the step of:
transmitting metadata from the media service to the second portable device via the network wherein the metadata is associated with the media file.

19. The method of claim 16 further comprising the step of:
compiling a list of media files transmitted to the first portable device wherein the second portable device is authorized to receive the second copy of the media file if the list of media files transmitted to the first portable device indicates that the media file was transmitted to the first portable device.

20. The method of claim 16 further comprising the step of:
determining if the user has a subscription to the media service wherein the subscription to the media service indicates that the second portable device is authorized to receive a second copy of the media file.
